(19) United States
(12) Patent Application Publication
(10) Pub. No.: US 2006/0288132 A1
(43) Pub. Date: Dec. 21, 2006

(54) Memory single-to-multi load repeater architecture

(76) Inventors: James A. McCall, Beaverton, OR (US); Pete D. Vogt, Boulder, CO (US)

Correspondence Address: BUCKLEY, MASCHOFF, TALWALKAR LLC, 5 ELM STREET, NEW CANAAN, CT, 06840, US

(21) Appl. No.: 11/141,668

(22) Filed: May 31, 2005

(51) Int. Cl. G06F 13/00

(52) U.S. Cl. 710/31

(57) ABSTRACT

According to some embodiments, data is transmitted from a host to a first memory unit in a group of memory units. The data may then be repeated from the first memory unit to another memory unit in the group.

### BACKGROUND

Increasing memory density in a processing system can improve the system's performance. For example, stacking memory units on top of each other might let a system process more information (or process the information more efficiently) as compared to a similarly sized system that does not stack memory units. Moreover, increasing the rate at which information is stored into and/or retrieved from the memory units can improve the system's performance. At relatively high data rates, however, the integrity of electrical signals sent to and from a dense area of memory units may be degraded.

### BRIEF DESCRIPTION OF THE DRAWINGS

FIG. 1 is a block diagram of an apparatus.

FIG. 2 is a side view of a circuit board.

FIG. 3 illustrates a block diagram of an apparatus according to some embodiments.

FIG. 4 is a side view of a circuit board according to some embodiments.

FIG. 5 is a flow diagram illustrating a method according to some embodiments.

FIG. 6 is a side view of a circuit board according to another embodiment.

FIG. 7 is a side view of a circuit board according to still another embodiment.

FIG. 8 is a side view of a circuit board according to yet another embodiment.

FIG. 9 is a block diagram of a system according to some embodiments.

### DETAILED DESCRIPTION

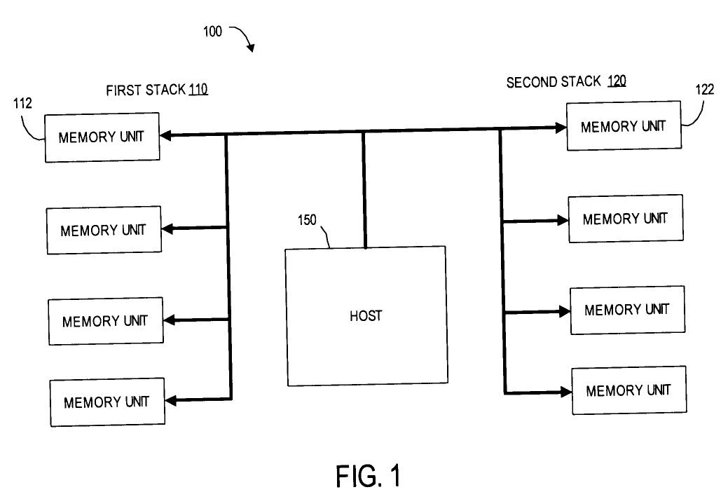

FIG. 1 is a block diagram of an apparatus 100 that includes a first set of memory units 112. The first set of memory units 112 may be, for example, any type of Random Access Memory (RAM) units, such as Dynamic RAM (DRAM) units, Static RAM (SRAM) units, Synchronous DRAM (SDRAM) units, and/or Double Data Rate (DDR) SDRAM units.

The first set of memory units 112 form a first “stack” 110. As used herein, memory units may be physically stacked by being placed substantially on top of each other, such as in a Single In-line Memory Module (SIMM), a Dual In-line Memory Module (DIMM), or a Small Outline DIMM (SODIMM). This approach may help increase the density of memory on a circuit board.

The apparatus 100 also includes a second set of memory units 122 (that form a second stack 120) and a host 150 that facilitates storing information into, and retrieving information from, the memory units 112, 122. The host 150 might comprise, for example, a Memory Controller Hub (MCH) that facilitates data exchanges between a processor and the memory units 112, 122.

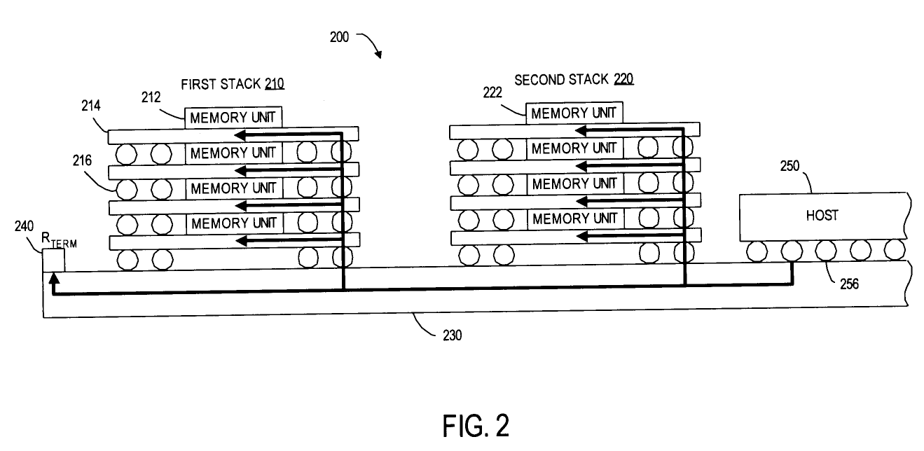

The host 150 may exchange information with each of the memory units 112, 122 directly. That is, there is a direct “multi-drop” path between the host 150 and each memory unit 112, 122. FIG. 2 is a side view of a circuit board 200 that includes a first set of memory units 212 (forming a first stack 210), a second set of memory units 222 (forming a second stack 220), and a host 250 that are configured to communicate using this approach.

The bottom memory unit 212 in the first stack 210 may be mounted on a memory board 214 which in turn is attached to a substrate 230 via contacts 216. The contacts 216 might comprise, for example, Integrated Circuit (IC) pins and/or ball-joint contacts. The next memory unit 212 in the first stack 210 is mounted on another memory board 214, which in turn is attached the memory board 214 of the bottom memory unit 212 via contacts 216. In this way, the memory units 212 form the first stack 210.

The host 250 is also coupled to the substrate 230 via contacts 256. Traces on the substrate 230 may form conductive paths between the host 250 and the two stacks 210, 220, providing a multi-drop bus that connects with the two stacks 210, 220 in parallel.

This approach, however, may result in electrical performance problems at relatively high data rates, such as rates higher than one Gigabit-per-second (Gb/s). For example, increased noise levels, latencies, and/or reflections may degrade the integrity of the signal between the host 250 and the stacks 210, 220 to an unacceptable level. A terminal resistance (RTERM) 240 placed at the end of the signal path might improve signal integrity (e.g., by reducing an amount of signal reflection), but the improvement might still not be sufficient to enable data exchanges at high data rates.

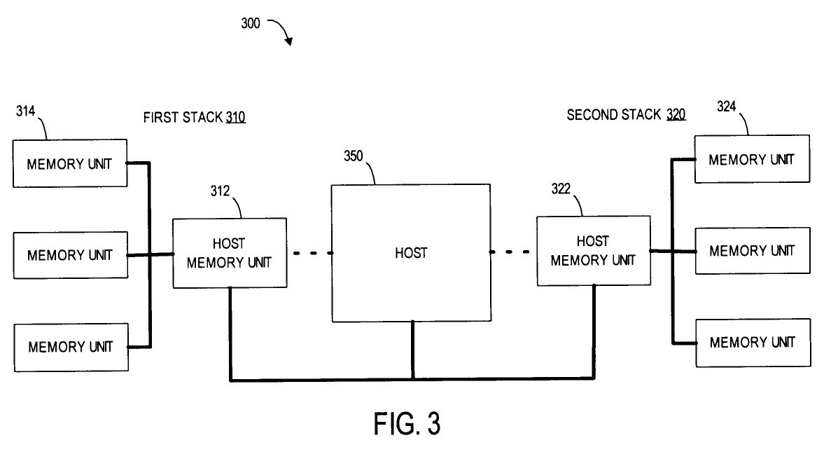

FIG. 3 is a block diagram of an apparatus 300 according to some embodiments. In this case, the apparatus 300 includes a first set of memory units 312, 314, such as any of the types of memory unit described with respect to FIG. 1, forming a first stack 310 (e.g., a DIMM stack).

The apparatus 300 also includes a second set of memory units 322, 324 (forming a second stack 320) and a host 350 that facilitates storing information into, and retrieving information from, the memory units 312, 314, 322, 324 (e.g., a chipset's MCH).

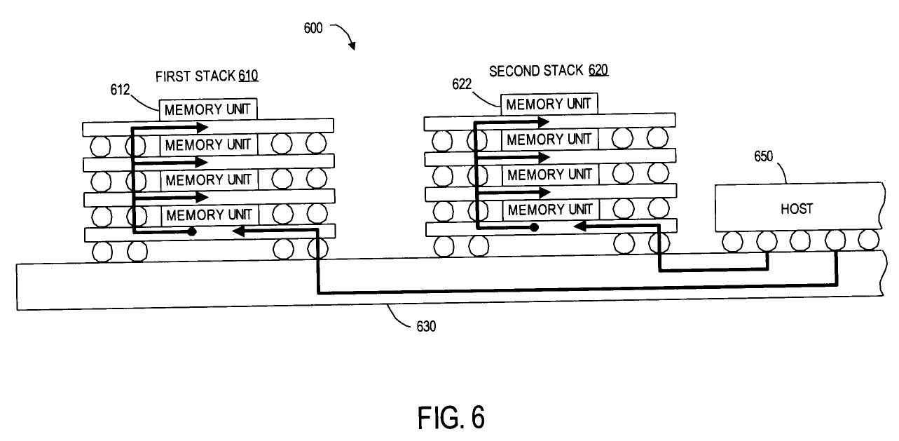

According to this embodiment, the host 350 exchanges information with one of the memory units 312 in the first stack 310, referred to herein as the “host” memory unit 312. That host memory unit 312 may, in turn, exchange information with the other memory units 314 in that stack 310. Similarly, the host 350 exchanges information with a host memory unit 322 in the second stack 320, which in turn may exchange information with the other memory units 324 in that stack 320. Note that the host 350 may exchange information with both host memory units 312, 322 via a single line. According to another embodiment (represented by dotted lines in FIG. 3 and discussed in more detail with respect to FIG. 6), the host 350 exchanges data with the host memory units 312, 322 via different paths.

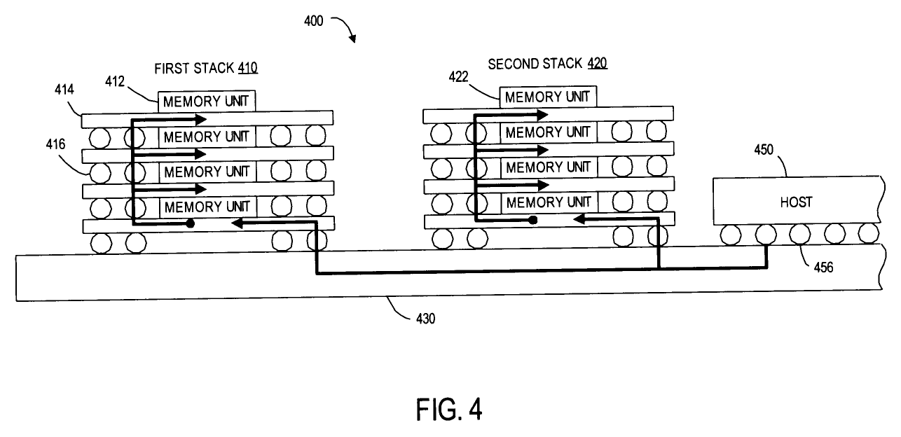

In this approach, there is a single, direct “mutli-drop” connection between the host 350 and the two stacks 310, 320 (via the host memory units 312, 322) and a “star” topology within each stack (between the host memory unit and the other memory units in that stack). FIG. 4 is a side view of a circuit board 400 that includes two memory unit stacks 410, 420 and a host 450 that are configured to communicate using this approach.

As before, the bottom memory unit 412 in the first stack 410 is mounted on a memory board 414 which, in turn, is attached to a substrate 430 via contacts 416 (e.g., ball-joint contacts). The next memory unit 412 in the first stack 410 is mounted on another memory board 414 which in turn is attached the memory board 414 of the bottom memory unit 412 via contacts 416. In this way, the memory units 412 form the first stack 410.

The host 450 is also coupled to the substrate 430 via contacts 456. Traces on the substrate 430 may form one or more conductive paths between the host 450 and the two stacks 410, 420, such as a multi-drop bus that connects to the two stacks 410, 420 in parallel.

In this case, however, the host 450 is only coupled to one memory unit in each of the two stacks 410, 420. In the example illustrated in FIG. 4, the bottom memory unit in each stack 410, 420 has been configured to act as the host memory unit. Note that other memory units in the stack could be selected instead. Each host memory unit is also directly coupled to the other memory units in that stack (e.g., via contacts 416 between the memory circuit boards 414). The memory units 422 in the second stack 420 are similarly configured.

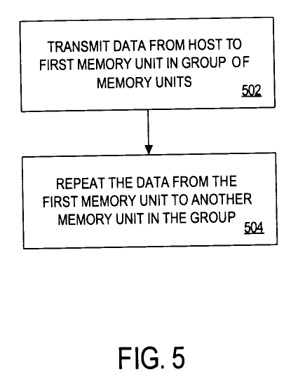

FIG. 5 is a flow diagram illustrating a method according to some embodiments. The flow chart does not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 502, data is transmitted from a host to a first memory unit in a group of memory units. For example, a MCH may transmit data to a first memory unit in a stack of DRAM units in a DIMM. The data may be transmitted, for example, via a uni-directional link or a bi-directional link.

At 504, the data is “repeated” from the first memory unit to another memory unit in the group. For example, the first memory unit might buffer information received from the host. If the information is destined to be stored in another memory unit in the stack, the first memory unit would repeat the information by transmitting it to the other memory unit. If the information was instead destined to be stored within the first memory unit, of course, it would not need to be repeated to another memory unit. According to some embodiments, the first memory unit can route information received from the host to any of a number of other memory units in the stack.

The first memory unit may be configured to operate using a “repeat mode” function. For example, the host might configure the first memory unit to operate in a repeat mode during a hardware or software initialization process. In addition, memory units in the stack may be configured to activate an on-die terminal resistance.

Note that a high-speed point-to-point interface may be provided for the relatively long link between the host and a stack while a multi-drop star topology is used for communications within the stack. Such an approach may improve signaling characteristic performance problems at relatively high data rates, such as rates higher than one Gb/s.

In the example illustrated in FIG. 4, the host 450 exchanges data between itself and the two stacks 410, 420 over a single communication link. FIG. 6 is a side view of a circuit board 600 according to another embodiment. As before, the host 650 has a direct point-to-point link with a single host memory unit 612 in a first stack 610. In this case, however, the host 650 has a second, separate, point-to-point link with a single host memory unit 622 in a second stack 620. For example, two separate paths may be formed on or in a substrate 630. This approach may further improve signaling characteristics (e.g., such a design might be operable at data rates up to ten times faster as compared to the approach described with respect to FIGS. 1 and 2).

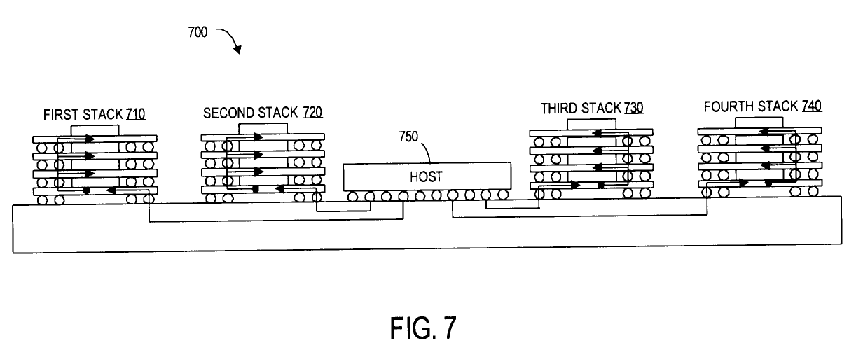

Although two stacks 610, 620 are illustrated in FIG. 6, embodiments may include any number of stacks. For example, FIG. 7 is a side view of a circuit board 700 that includes a host 750 and four memory stacks 710, 720, 730, 740. In this case, the host 750 has been placed between the second stack 720 and the third stack 730 (e.g., to reduce the length of the longest point-to-point communication link). Note that although four memory units are illustrated in each stack, a stack might include any number of memory units (as long as the number is greater than one).

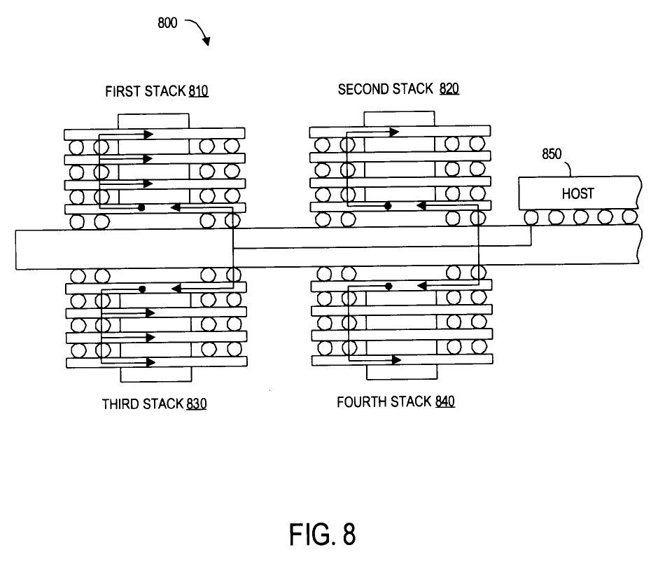

FIG. 8 is a side view of a circuit board 800 according to still another embodiment. In this case, a host 850 exchanges information with two stacks 810, 820 that are mounted on one side of a substrate and two stacks 830, 840 that are mounted on the opposite side (e.g., to further increase memory density). In this example, the first stack 810 may include a first integrated circuit memory to receive data from a provider (e.g., the host 850) through a point-to-point interface. A second integrated circuit memory stacked with the first integrated circuit memory may then receive the data from the first integrated circuit memory through a star-topology interface. Similarly, a third integrated circuit memory stacked with the first and second integrated circuit memories might also receive data from the first integrated circuit memory through that star-topology interface.

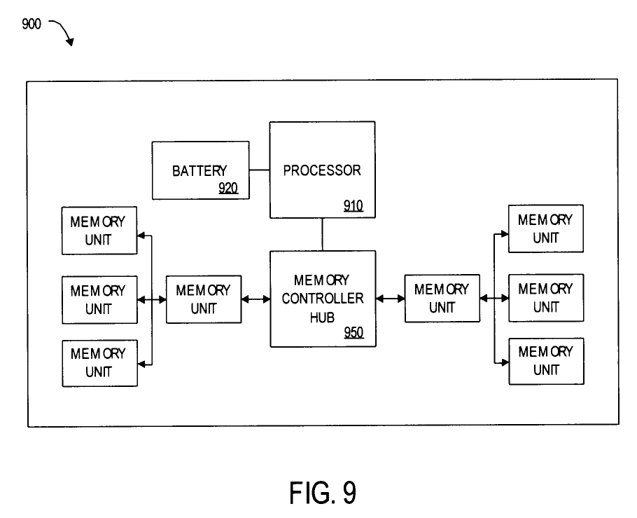

FIG. 9 is a block diagram of a system 900 according to some embodiments. The system 900 might be associated with, for example, a mobile or desktop computer, a game system, a server, or a media center. The system 900 includes a processor 910 that accesses memory units via a memory controller hub 950 in accordance with any of the embodiments described herein. For example, the system 900 may include a first group of integrated circuit memories connected through a first star-topology interface, a second group of integrated circuit memories connected through a second star-topology interface, and a host coupled to the first group through a first point-to-point interface and to the second group through a second point-to-point interface. According to some embodiments, the system 900 also includes a battery 920 (e.g., to provide power to the processor 910 or any other device in the system 900).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although memory units are physically “stacked” on top each other in some of the embodiments described herein, memory units might instead be stacked or otherwise grouped by being located relatively close to each other. In addition, die stacking could be utilized instead of, or in addition to, package stacking. Moreover, each stack has been configured to have a single host memory unit in some of the embodiments described herein, but a single stack might instead have multiple host memory units (e.g., a first host memory unit could repeat data to three other memory units in the stack while a second host memory unit repeats data to three different memory units in that stack).

According to another embodiment, a host or other device can selectively configure (or re-configure) the host memory unit for a stack. For example, when a default host memory unit fails the host might re-configure the stack such that a secondary or “back-up” memory unit act as the host memory unit.

The several embodiments described herein are solely for the purpose of illustration. Persons skilled in the art will recognize from this description other embodiments may be practiced with modifications and alterations limited only by the claims.

What is claimed is:

1. A method, comprising:
transmitting data from a host to a first memory unit in a group of memory units; and
repeating the data from the first memory unit to another memory unit in the group.

2. The method of claim 1, wherein data is repeated from the first memory unit to one of a plurality of other memory units in the group as appropriate.

3. The method of claim 1, wherein said transmitting is performed via a first path and further comprising:
transmitting second data from the host to a first memory unit in a second group of memory units; and
repeating the data from the first memory unit in the second group to another memory unit in the second group.

4. The method of claim 3, wherein the transmission of data to the first and second groups are performed via the same communication link.

5. The method of claim 3, wherein the transmission of data to the first and second groups are performed via different communication links.

6. The method of claim 1, wherein the group of memory units is stacked.

7. The method of claim 6, wherein the stacked memory units are associated with a dual in-line memory module.

8. The method of claim 1, wherein the memory units are dynamic random access memory units.

9. The method of claim 1, further comprising:
prior to said transmitting, configuring the first memory unit to buffer received data and to repeat the buffered data to the other memory unit in the group.

10. The method of claim 9, wherein said configuring is associated with at least one of: (i) a software initialization, or (ii) a hardware initialization.

11. The method of claim 9, wherein said repeating is performed using a repeat mode function.

12. The method of claim 1, wherein at least one of said transmitting or receiving is performed from a memory controller hub.

13. The method of claim 1, wherein said transmitting is associated with one of: (i) a uni-directional link, or (ii) a bi-directional link.

14. The method of claim 1, wherein the data is repeated from the first memory unit to a second memory unit and further comprising:
repeating the data from the second memory unit to still another memory unit in the stack.

15. The method of claim 1, wherein the memory unit receiving the repeated data includes an on-die terminal resistance.

16. An apparatus, comprising:
a first integrated circuit memory to receive data from a provider through a point-to-point interface;
a second integrated circuit memory stacked with the first integrated circuit memory, wherein the second integrated circuit memory is to receive the data from the first integrated circuit memory through a star-topology interface; and
a third integrated circuit memory stacked with the first and second integrated circuit memories, wherein the third integrated circuit memory is to also receive data from the first integrated circuit memory through the star-topology interface.

17. The apparatus of claim 16, wherein the provider is associated with a memory controller hub.

18. The apparatus of claim 16, wherein the first integrated circuit memory is configured to buffer received data and to repeat the buffered data to the second and third integrated circuit memories.

19. An apparatus, comprising:
a storage medium having stored thereon instructions that when executed by a machine result in the following:
transmitting data from a memory controller hub to a first memory unit in a stack of memory units; and
repeating the data from the first memory unit to another memory unit in the stack.

20. The apparatus of claim 19, wherein execution of the instructions further results in:
prior to said transmitting, configuring the first memory unit to buffer the data and to repeat the buffered data to the other memory unit.

21. The apparatus of claim 20, wherein said configuring is associated with an initialization process.

22. A system, comprising:
a first group of integrated circuit memories connected through a first star-topology interface;
a second group of integrated circuit memories connected through a second star-topology interface;
a host coupled to the first group through a first point-to-point interface and to the second group through a second point-to-point interface; and
a battery to provide power for the system.

23. The system of claim 22, wherein an integrated circuit memory in the first group is coupled to both the first star-topology interface and the first point-to-point interface and an integrated circuit memory in the second group is coupled to both the second star-topology interface and the second first point-to-point interface.

24. The system of claim 22, wherein the first group of integrated circuit memories comprises a first dual in-line memory module mounted on a first side of a circuit board and the second group of integrated circuit memories comprises a second dual in-line memory module mounted on a second side of the circuit board, the second side being opposite the first side.
